(19) United States
(12) Patent Application Publication
(10) Pub. No.: US 2019/0009762 A1
(43) Pub. Date: Jan. 10, 2019

(54) MOTOR VEHICLE HAVING A RECUPERATIVE BRAKING MODE

(71) Applicant: VOLKSWAGEN AKTIENGESELLSCHAFT, Wolfsburg (DE)

(72) Inventors: Leo SCHINELLER, Wasbüttel (DE); Frank RISCHBIETER, Lehre (DE)

(21) Appl. No.: 15/748,705

(22) PCT Filed: Jul. 26, 2016
(86) PCT No.: PCT/EP2016/067762

§ 371 Date: Jan. 30, 2018

(30) Foreign Application Priority Data
Aug. 7, 2015 (DE) 10 2015 215 126.3

(51) Int. Cl. B60T 8/34

(52) U.S. Cl. CPC B60T 8/348; B60T 8/4275

(57) ABSTRACT

A hydraulic brake for a motor vehicle in which one inlet valve and one outlet valve, configured in the switchable fashion, is respectively made available for at least one wheel, wherein the inlet valve is fluidly coupled to the outlet valve downstream of the inlet valve via a brake pressure line, and wherein a hydraulic accumulator for storing hydraulic fluid is made available downstream of the outlet valve. The hydraulic accumulator is reaction-free in a recuperative braking mode. The brake pressure line is coupled to a piston of a brake lining of a friction brake of the wheel via a valve arrangement, wherein the valve arrangement has a first valve which opens only towards the piston, and a second valve which opens only towards the brake pressure line, and wherein an opening pressure of the first valve is higher than a residual pressure brought about by the hydraulic accumulator.

### PRIORITY CLAIM

This patent application is a U.S. National Phase of International Patent Application No. PCT/EP2016/067762, filed 26 Jul. 2016, which claims priority to German Patent Application No. 10 2015 215 126.3, filed 7 Aug. 2015, the disclosures of which are incorporated herein by reference in their entireties.

### SUMMARY

Illustrative embodiments relate to a hydraulic brake for a motor vehicle. The hydraulic brake has an inlet valve and an outlet valve, which is designed to be switchable, for each wheel, wherein a brake pressure line, via which the inlet valve and the outlet valve are coupled to one another and which leads to a piston of a brake pad of a friction brake of the wheel, is provided downstream of the inlet valve. A hydraulic accumulator for storing hydraulic fluid is provided downstream of the outlet valve. Illustrative embodiments also include a motor vehicle having the disclosed hydraulic brake.

### BRIEF DESCRIPTION OF THE DRAWINGS

An exemplary embodiment is described below. In this regard, the figures show:

FIG. 1 is a schematic illustration of an embodiment of the disclosed motor vehicle;

FIG. 2 is a schematic illustration of an embodiment of the disclosed hydraulic brake, which can be incorporated in the motor vehicle of FIG. 1; and

FIG. 3 is a schematic illustration of a valve arrangement as can be provided in the hydraulic brake of FIG. 2.

### DETAILED DESCRIPTION

To integrate the hydraulic brake described in a recuperative system, the displaced volume of hydraulic fluid has to be guided into the hydraulic accumulator via the outlet valve when the brake pedal is actuated so that brake pressure does not build up at the piston of the brake pad. However, the hydraulic accumulator produces a residual pressure in the brake pressure line, which presses on the piston of the brake pad of the brake disk of the wheel via the opened outlet valve. This impairs the efficiency with regard to the energy recovery in the recuperative braking mode.

A recuperative brake system for which the disclosed hydraulic brake is suitable is known, for example, from DE 10 2012 023 345 A1. According to this, for a regenerative braking procedure, a pressure reduction valve is opened for each brake after the actuation of a brake pedal and the activation of a generator so that a hydraulic fluid flows from the wheel brakes and thereby lowers the brake pressure in the wheel brakes. The hydraulic braking torque is therefore not built up to the same extent as the total braking torque, which additionally comprises the generator torque.

It is known from DE 10 2012 203 779 A1 that, in purely regenerative or recuperative braking, a build up of brake pressure in a brake circuit of a brake system is limited to a response pressure of a storage volume of the brake circuit. This takes place by controlling a wheel outlet valve of the brake circuit so that brake fluid is displaced out of the master brake cylinder and the first brake circuit and into the storage volume of the brake circuit via the wheel outlet valve.

The disclosed embodiments prevent the loss of efficiency described at the outset owing to the reaction of the hydraulic accumulator on the piston of the brake pad.

A hydraulic brake for a motor vehicle is provided. In the hydraulic brake, an inlet valve and an outlet valve, which is designed to be switchable, are provided in each case for at least one wheel. A brake pressure line, which couples the inlet valve hydraulically or fluidically to the outlet valve, is provided downstream of the inlet valve (and upstream of the outlet valve). In a manner known per se, a brake pressure can be built up in the brake pressure line via the inlet valve by closing the outlet valve, which brake pressure then acts on a piston of a brake pad of a friction brake of the wheel and thereby brings about a braking effect of a brake disk of the wheel in a known manner. A low pressure accumulator or hydraulic accumulator for storing hydraulic fluid is furthermore provided downstream of the outlet valve in the hydraulic brake.

To prevent a buildup of brake pressure in the brake pressure line during regenerative or recuperative braking, it is possible to switch the outlet valve to an open position during the actuation of a brake pedal so that brake fluid can escape from the brake pressure line and into the hydraulic accumulator through the outlet valve. However, in the manner described at the outset, the residual pressure of the hydraulic accumulator then reacts in the brake line as a result of the outlet valve. The residual pressure in the hydraulic accumulator is produced, for example, by a pressure spring, which exerts a static pressure on the hydraulic fluid stored in the hydraulic accumulator. To now prevent this residual pressure from also acting on the piston of the brake pad, it is provided that the brake pressure line is coupled to the piston of the brake pad via a valve arrangement. The valve arrangement here has two valves, a first valve which only enables a flow in the direction of the piston and a second valve which only enables a flow in the direction of the brake pressure line. An opening pressure of the first valve which is directed from the brake pressure line towards the piston in the flow-enabling direction is higher than the residual pressure brought about by the hydraulic reservoir. As a result of the opening pressure of the first valve being higher than this residual pressure, the hydraulic accumulator is not able to transfer the residual pressure to the piston of the brake pad because this is arranged fluidically downstream with respect to the valve arrangement.

During the regenerative or recuperative braking mode, the outlet valve of the hydraulic brake can be brought into an open position without the hydraulic accumulator thereby reacting on the piston of the brake pad of the friction brake with its residual pressure. It is therefore possible for the brake pad to remain free of contact with the brake disk so that a loss of efficiency is not produced during the recuperative braking mode as a result of the brake pad rubbing against the brake disk.

To implement the recuperative braking mode, a further development provides that, depending on a signal signaling a recuperative braking mode, i.e., signaling the activity of an electric machine in generator mode, for example, the outlet valve is switched to an open position so that a fluid flow produced upstream of the inlet valve by an actuated brake pedal is discharged through the inlet valve, past the valve arrangement, through the outlet valve and into the hydraulic accumulator. The valve arrangement does not influence the recuperative braking mode.

According to a further development, the opening pressure of the first valve is in a range of 1 bar to 3 bar. In hydraulic braking mode when brake pressure is built up in the brake pressure line to operate the friction brake, the driver is unable to feel any resistance of the valve arrangement during hydraulic braking owing to the relatively low opening pressure of the first valve.

According to a further development, an opening pressure of the second valve is in a range lower than 0.8 bar. The restoring or return of the brake pad into the rest position and the end of a hydraulic braking procedure is not hindered or delayed by the valve arrangement.

According to a further development, the valve arrangement is integrated in a valve block. The valve block provides that the inlet valve and the outlet valve, together with at least one further inlet valve and at least one further outlet valve for a further wheel in each case, are integrated in the valve block. The valve arrangement is then likewise integrated in this valve block. The valve block can be provided as an installation part and this valve block is already designed to be non-reactive with regard to the piston of the brake pad in a recuperative braking mode. Such a valve block can be, for example, an integral part of an electronic stability control (ESC) which should be realized with as few components as possible, namely according to the so called 2-box principle based on a main valve and the valve block.

According to an alternative further development, the valve arrangement is designed as an individually mountable intermediate piece via which the brake pressure line and the friction brake are mechanically coupled. For example, such an intermediate piece can be screwed to the described valve block, i.e., to an output of the brake pressure line integrated in the valve block. This further development is beneficial in that the valve arrangement can be integrated in an existing brake circuit as a retrofit part.

According to an alternative further development, the valve arrangement is integrated in a brake caliper of the friction brake. The friction brake is itself protected against the reaction of the hydraulic accumulator and its residual pressure.

According to a further development, the first valve and the valve in the valve arrangement are hydraulically connected in parallel, i.e., the valve arrangement has a common first connection for connecting both the first valve and the second valve to the brake pressure line and a common second connection for connecting both the first valve and the second valve to the friction brake. In other words, starting from the first connection, a branched hydraulic line is provided, which fluidically couples the first connection both to the first valve and to the second valve. Equally, the second connection is fluidically coupled both to the first valve and to the second valve via a branched hydraulic line. The further development is beneficial in that the total of four valve openings of the two valves can be connected to a hydraulic circuit via only two connections.

To realize a robust and, in terms of its manufacture, economical embodiment of the hydraulic brake, a further development provides that the first valve and/or the second valve are formed by a spring-mounted ball valve in each case. Small control lines are then required to control the valve positions of the valves.

According to a further development, it is provided that a valve arrangement is only provided for two wheels in each case, for example, the two rear wheels or the two front wheels. Alternatively, it is provided that a valve arrangement is provided for four wheels of the motor vehicle in each case. In other words, for at least one axle of the motor vehicle (front axle, rear axle), a valve arrangement of the type described is provided for its two wheels in each case.

As already mentioned, disclosed embodiments also include a motor vehicle. The disclosed motor vehicle has an embodiment of the disclosed hydraulic brake. The disclosed motor vehicle is therefore set up for an efficient recuperative braking mode.

The disclosed motor vehicle may be designed as an automobile, in particular, as a truck or car.

A further development of the motor vehicle enables the recuperative braking mode in that an electric machine is designed to brake the motor vehicle in the recuperative braking mode by converting kinetic energy of the motor vehicle into electrical energy. A computing device is designed to initiate the recuperative braking mode depending on an actuation of a brake pedal of the motor vehicle, as is known per se, and, with this, to signal the recuperative braking mode to the hydraulic brake via a signal. The outlet valve can then be opened in the manner described, for example, as a result of the signal. The computing device can be provided, for example, by a control device of the motor vehicle. The computing device can comprise, for example, a microcontroller or a microprocessor.

In the exemplary embodiment, the described components of the embodiment each represent individual features of the disclosure which can be regarded independently of one another and which also develop the disclosure independently of one another in each case and can therefore be also viewed, individually or in a combination other than that shown, as an integral part of the disclosure. The embodiment described can also be supplemented by others of those features of the disclosure which have already been described.

Functionally identical elements are each denoted by the same reference signs in the figures.

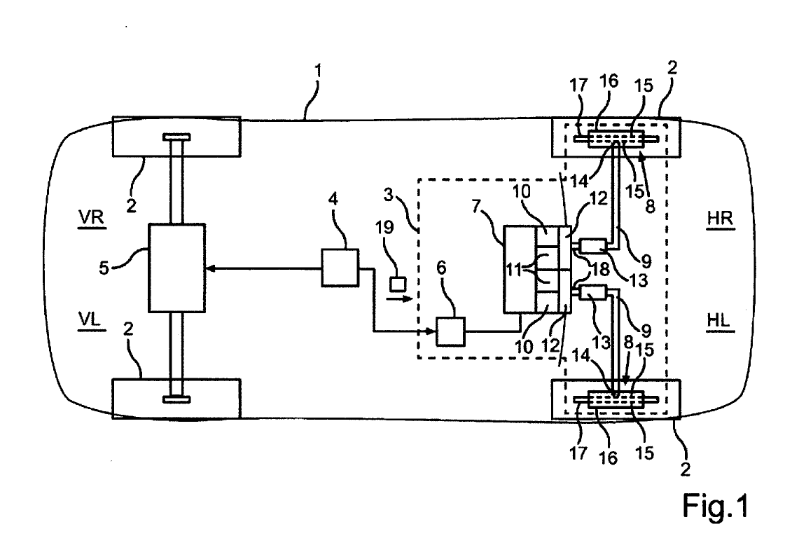

FIG. 1 shows a bird's eye view of a motor vehicle 1 which can be, for example, an automobile, in particular, a car. Wheels 2, part of a hydraulic brake 3, a computing device 4 and an electric machine 5 are shown.

The electric machine 5 can be a drive motor of the motor vehicle 1. It can also be provided that the motor vehicle 1 additionally or alternatively has an internal combustion engine, which is not illustrated in FIG. 1. The electric machine 5 can also be designed, for example, as a starter-generator. The electric machine 5 can be mechanically coupled to two of the wheels 2, for example, to thereby brake the coupled wheels 2 in generator mode and thereby enable a recuperative braking mode of the motor vehicle 1.

Of the hydraulic brake 3, a control device 6, a valve block 7, friction brakes 8 for the rear wheels and hydraulic lines 9 are shown in FIG. 1. The valve block 7 can have an inlet valve 10 and an outlet valve 11 for each friction brake 8, which are fluidically coupled to one another by a brake pressure line 12 in each case. The friction brakes 8 and the associated inlet valve 10 and outlet valve 11 are differentiated in FIG. 1 by the following reference signs for the vehicle wheels: HR—rear right, HL—rear left. Friction brakes 3 (not illustrated) can equally be provided by the hydraulic brake 3 for the front wheels VR—front right—and VL—front left.

The respective brake pressure line 12 is fluidically coupled in each case to a piston 14 of one of the friction brakes 8 here via a valve arrangement 13 and, for example, via one of the hydraulic lines 9. The piston 14 acts on brake pads 15, which can be arranged, for example, in a brake caliper 16 of the friction brake. When the piston 14 is acted upon by a brake pressure, the brake pads 15 rub against a brake disk 17 of the friction brake 8 and thereby brake the respective wheel 2.

Each of the valve arrangements 13 can be integrated in the valve block 7. The valve arrangements 13 can alternatively be arranged on a connection 18 of the valve block 7 and, to this end, be provided as an intermediate piece for connecting the valve block 7 and the hydraulic line 9. The valve arrangements 13 can equally also be provided in each case as an intermediate piece between the hydraulic line 9 and the brake caliper 16. Finally, each valve arrangement 13 can also be integrated in the brake caliper 16 of the respective friction brake 8 in each case.

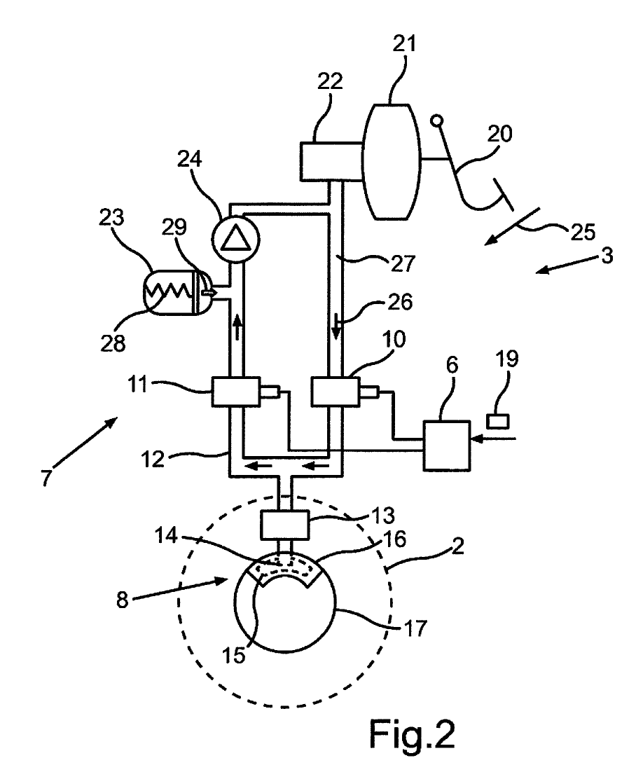

To brake the motor vehicle 1 via a recuperative braking mode, the electric machine 5 is switched to generator mode by the computing device 4. To this end, the computing device 4 can be designed, for example, as a control device. The computing device 4 furthermore signals via a signal 19 to the control device 6 of the hydraulic brake 3 that the recuperative braking mode has been initiated. The control device 6 then implements the control procedure (described below) in the hydraulic brake 3 to realize the recuperative braking mode as efficiently as possible. Please refer to the following FIG. 2 for explanation.

FIG. 2 again shows the hydraulic brake 3 in more detail using the example of an individual wheel 2. In addition to the elements illustrated in FIG. 1, a brake pedal 20, a brake booster 21, a master cylinder 22, a hydraulic accumulator 23 and a pump 24 are further shown. As a result of a brake pedal actuation 25 of the brake pedal 2, a fluid flow 26 of a brake fluid 27 is produced in a manner known per se by the master cylinder 22. Owing to, or depending on, the signal 19, the control device 6 switches the inlet valve 10 and the outlet valve 11 to an open position, whereby the fluid flow 26 from the master cylinder 22 arrives in the brake pressure line 12 through the inlet valve 10. The fluid flow 26 flows past the valve arrangement 13 through the outlet valve 11 and into the hydraulic accumulator 23. The hydraulic accumulator 23 therefore receives the volume of hydraulic fluid which has been displaced in the master cylinder 22 through the actuation 25 of the brake pedal 20. The hydraulic accumulator 23 can have a spring 28 which generates or builds up a residual pressure 29 which reacts in the brake pressure line 12 as a result of the opened outlet valve 11. As a result of the valve arrangement 13 remaining closed here, brake pressure is not built up on the piston 14, i.e., the residual pressure 29 does not act on the piston 14.

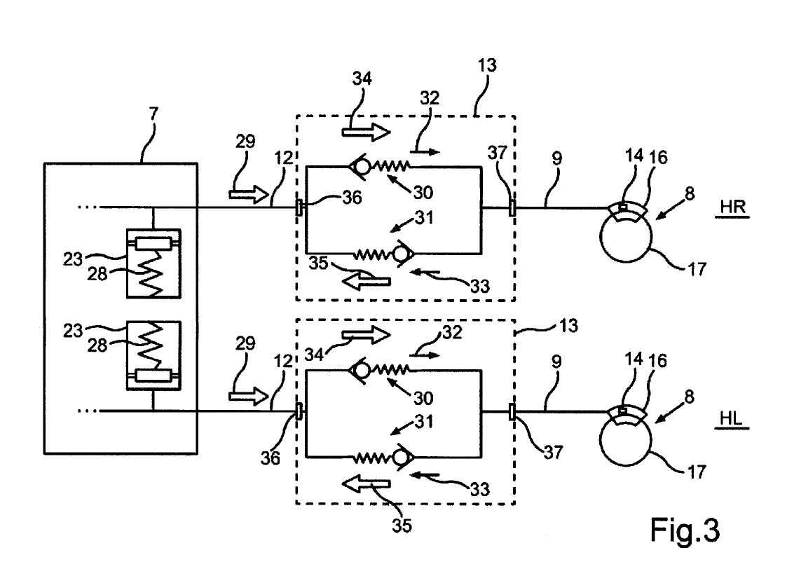

Owing to the valve arrangement 13, the reaction of the hydraulic accumulator 23 on the piston 14 of the friction brake 8 as a result of the residual pressure 29 is therefore prevented. The reason for this is the design of the valve arrangement 13, which is described below in conjunction with FIG. 3.

In this regard, FIG. 3 again shows the arrangement comprising the hydraulic accumulator 23, the valve arrangement 13 and the friction brake 8 for the two rear wheels HR, HL. For the sake of clarity, the respective outlet valve 11 has not been shown since it is in an open position in any case during the recuperative braking mode and does not act on the hydraulic circuit of the hydraulic brake 3.

The valve arrangement 13 has a first valve 30 and a second valve 31. The valves 30, 31 can be a spring-mounted ball valve in each case. In other words, the valves 30, 31 may be non-return valves. The first valve 30 has a flow-enabling direction 32 which is aligned from the brake pressure line 12 towards the piston 14 of the friction brake 8. The second valve 31 has a flow-enabling direction 33 which is aligned from the piston 14 towards the brake pressure line 12. A brake pressure can be transferred from the brake pressure line 12 to the piston 14 via the first valve 30. The brake pressure on the piston 14 can be reduced via the second valve 31. The first valve 30 has an opening pressure 34 which may be higher than 1 bar, in particular, higher than 1.5 bar, although, in particular, lower than 10 bar, in particular, lower than 5 bar. The opening pressure 34 is generally higher than the residual pressure 29 which is produced by the spring 28 of the hydraulic accumulator 23. The opening pressure 35 of the second valve 31 may be lower than 1 bar, in particular, lower than 0.5 bar.

As a result of the first valve 30 having an opening pressure 34 which is higher than the residual pressure 29 and the second valve 31 having a flow-enabling direction 33 which is in opposition to the residual pressure 29, the residual pressure 29 does not act on the piston 14 during the recuperative braking mode in spite of the opened outlet valve 11. Therefore, the valve arrangement 13 prevents the brake pads 15 from being pressed against the brake disk 17 of the friction brake 8 as a result of the residual pressure 29. A loss of efficiency owing to friction is therefore prevented.

In each valve arrangement 13, the valves 30, 31 can be connected to the brake pressure line 12 via a respective common first connection 36. The two valves 30, 31 can be connected to the friction brake 8 via a common second connection 37.

The valve arrangement illustrated in FIG. 1 to FIG. 3 is merely to be seen as an example of the operating principle. At least two or even all four friction brakes 8 of the wheels 2 can be equipped depending on the hydraulic implementation. The threshold pressure valves, i.e., the valves 30, 31, can be integrated, for example, in an electronic stability control ESC in the valve block 7, or provided on the brake pressure line 12 in the hydraulic line 9 or they can be arranged in the brake caliper 16. The valve arrangement 13 described does not influence the function of the hydraulic accumulator 23 since the valve arrangement 13 is not arranged in the flow path of the brake pressure line 12.

Each valve arrangement 13 represents a hydraulic component which is mounted on the brake line connection, on or in the valve block 7, in the direction of the wheel. This component opens the passage to the wheel only when a pressure of, for example, 1 to 2 bar is applied, so that it does not produce a residual braking torque on the friction brake 8 in this phase. This component also acts during normal braking but, owing to the opening pressure which is selected for the first valve 30, it does not cause a hindrance to braking which can be felt by the driver.

All in all, therefore, the example shows how a threshold-pressure-dependent switching device can be provided in conjunction with a 2-box brake system.

### LIST OF REFERENCE SIGNS

1 Motor vehicle
2 Wheel
3 Hydraulic brake
4 Computing device
5 Electric machine
6 Control device
7 Valve block
8 Friction brake
9 Hydraulic line
10 Inlet valve
11 Outlet valve
12 Brake pressure line
13 Valve arrangement
14 Piston
15 Brake pad
16 Brake caliper
17 Brake disk
18 Connection
19 Signal
20 Brake pedal
21 Brake booster
22 Master cylinder
23 Hydraulic accumulator
24 Pump
25 Pedal actuation
26 Fluid flow
27 Brake fluid
28 Spring
29 Residual pressure
30 First valve
31 Second valve
32 Flow-enabling direction
33 Flow-enabling direction
34 Opening pressure
35 Opening pressure
36 First connection
37 Second connection

1. A hydraulic brake for a motor vehicle, the hydraulic brake comprising:
an inlet valve; and
an outlet valve,
wherein the inlet valve and the outlet valve are switchable,
wherein the hydraulic brake is provided for at least one wheel,
wherein the hydraulic brake further comprises:
a brake pressure line fluidically coupled to both the inlet valve and the outlet valve downstream of the inlet valve;
a hydraulic accumulator for storing hydraulic fluid provided downstream of the outlet valve,
a piston of a brake pad of a friction brake of the wheel being coupled to the brake pressure line via a valve arrangement, wherein the valve arrangement has a first valve which only enables a flow in the direction of the piston and a second valve which only enables a flow in the direction of the brake pressure line,
wherein an opening pressure of the first valve is higher than a residual pressure brought about by the hydraulic reservoir.

2. The hydraulic brake of claim 1, further comprising a control device, wherein, depending on a signal signaling a recuperative braking mode, the control device switches the outlet valve to an open position so that a fluid flow produced upstream of the inlet valve by an actuated brake pedal is discharged through the inlet valve, past the valve arrangement, through the outlet valve and into the hydraulic reservoir.

3. The hydraulic brake of claim 1, wherein the opening pressure of the first valve is in a range of 1 bar to 3 bar.

4. The hydraulic brake of claim 1, wherein an opening pressure of the second valve is in a range lower than 0.8 bar.

5. The hydraulic brake of claim 1, wherein the inlet valve and the outlet valve, together with at least one further inlet valve and at least one further outlet valve for a further wheel are integrated in a valve block and the valve arrangement is integrated in the valve block.

6. The hydraulic brake of claim 1, wherein the valve arrangement is designed as an individually mountable intermediate piece via which the brake pressure line and the friction brake are mechanically coupled.

7. The hydraulic brake of claim 1, wherein the valve arrangement is integrated in a brake caliper of the friction brake.

8. The hydraulic brake of claim 1, wherein the valve arrangement has a common first connection for connecting both the first valve and the second valve to the brake pressure line and a common second connection for connecting both the first valve and the second valve to the friction brake.

9. The hydraulic brake of claim 1, wherein the first valve and/or the second valve is a spring-mounted ball valve.

10. The hydraulic brake of claim 1, wherein a valve arrangement is provided for two wheels or for four wheels.

11. A motor vehicle having a hydraulic brake as claimed in claim 1.

12. The motor vehicle of claim 11, wherein an electric machine brakes the motor vehicle in a recuperative braking mode, and wherein a computing device initiates the recuperative braking mode depending on an actuation of the brake pedal of the motor vehicle and signals the recuperative braking mode to the hydraulic brake via a signal.
